(19) United States
(12) Patent Application Publication
(10) Pub. No.: US 2012/0276365 A1
(43) Pub. Date: Nov. 1, 2012

(54) Refractory Porous Ceramics

(76) Inventors: William Petuskey, Phoenix, AZ (US); Feng He, Jiangsu (CN)

(21) Appl. No.: 13/511,177

(22) PCT Filed: Nov. 23, 2010
(86) PCT No.: PCT/US10/57738

§ 371 Date: May 22, 2012

Related U.S. Application Data
(60) Provisional application No. 61/263,563, filed on Nov. 23, 2009.

(51) Int. Cl. C04B 35/50; B05D 3/02; B32B 5/02; E04B 1/78; C09D 1/00

(52) U.S. Cl. 428/311.51; 501/94; 252/62; 106/286.5; 428/319.1; 427/384

(57) ABSTRACT

A refractory, porous ceramic composite including crystalline mullite (3Al₂O₃+2SiO₂ or 3Al₆Si₂O₁₁) and a crystalline phase of LaPO₄ is formed from a mullite-LaPO₄ sol-gel by annealing the dried gel. During the annealing process, particle sintering and self-foaming occur in the glassy state, and pores are produced due at least in part to the release of entrapped gases that form during the pyrolysis of the gel. The resulting crystalline composite, or crystalline nanocomposite, has a high porosity and is dimensionally and chemically stable at high temperatures. The composite also has a high degree of structural (e.g., mechanical) stability, related at least in part to the fine texturing and mixing of the mullite and LaPO₄ during preparation of the sol. The resulting ceramic composite shows little or no shrinkage or expansion between about 1000C and about 1200° C.

### STATEMENT OF GOVERNMENT INTEREST

This invention was made with government support under AFOSR FA9550-07-1-0371 awarded by Air Force Office of Scientific Research. The government has certain rights in the invention.

### TECHNICAL FIELD

This invention generally relates to refractory porous ceramics.

### BACKGROUND INFORMATION

Traditional powder-based ceramic processing methods may include sintering of crystalline powders to form solid bridging between powder particles, imparting rigidity to a powder compact. Sintering may occur at a relatively slow rate, such that the crystalline powders densify and shrink, becoming more dense and less porous. The introduction of sintering aids to overcome this problem may compromise high-temperature performance of the product. As such, it has been difficult to fabricate ceramics with a high porosity (e.g., greater than about 50 vol %), high chemical and dimensional stability at high temperatures, and sufficient cohesive strength to hold fibers and fiber bundles in place within a matrix. In addition, homogeneous ceramics may be prone to thermal cycling fatigue, leading to early catastrophic failure.

### SUMMARY

In one aspect, a ceramic composite includes crystalline mullite, crystalline lanthanum phosphate, and a multiplicity of pores defined therein, wherein a porosity of the composite is between about 65% and about 90%.

In another aspect, a substrate includes a coating, wherein the coating includes a mullite-lanthanum phosphate crystalline composite with a porosity between about 65% and about 95%.

In another aspect, making a crystalline ceramic composite includes combining an aluminum alkoxide and a solvent to form a mixture and adding a silicon-containing compound, a lanthanum-containing compound, and a phosphorous-containing compound to the mixture. The mixture is processed to form a sol comprising mullite and lanthanum phosphate, and a liquid is evaporated from the sol to form a gel. The gel is dried to form a powder, and the powder is annealed to form a crystalline composite.

In another aspect, coating a substrate with a crystalline ceramic composite includes combining an aluminum alkoxide and a solvent to form a mixture, and adding a silicon-containing compound, a lanthanum-containing compound, and a phosphorous-containing compound to the mixture. The mixture is processed to form a sol including mullite and lanthanum phosphate. A substrate is coated with the sol, and the sol is dried to form a gel. The dried gel is annealed to form a mullite-lanthanum phosphate crystalline composite coating on the substrate.

Implementations may include one or more of the following features. The composite is a mullite-LaPO₄ composite or nanocrystalline composite. The porosity of the composite may be at least about 80% or at least about 85%. In some cases, the multiplicity of pores includes a bimodal pore distribution. The bimodal pore distribution includes a first set of pores with diameters in a range between about 1 micron and about 5 microns and a second set of pores with diameters in a range between about 10 nanometers and about 100 nanometers.

The composite, when heated at a temperature between about 1000° C. and about 1200° C. may exhibit a change in volume of less than 2% or less than 1%. A thermal conductivity of the composite may be less than about than 1 W/(m·K) at 1000° C.

In some cases, the composite is used to form a ceramic matrix, a thermal barrier coating, a thermal insulation brick, or a bonding layer between ceramic fibers and matrices in a continuous fiber ceramic composite. In some implementations, a coated substrate includes a fiber in a continuous fiber ceramic composite, a metal substrate, or a ceramic substrate.

In some cases, annealing the powder includes self-foaming of a glassy state of the powder. Annealing may include annealing at a temperature between about 900° C. and about 1400° C., between about 900° C. and about 1200° C., between about 900° C. and about 950° C., or at about 950° C.

In some implementations, the silicon-containing compound includes tetraethoxyorthosilicate. The phosphorous-containing compound may include trimethyl-hosphate. The aluminum alkoxide may include aluminum isopropoxide or aluminum sec-butoxide. The lanthanum-containing compound may include lanthanum nitrate or a hydrate thereof. The solvent may include ethanol. For example, the solvent may be ethanol. In some cases, the sol has a ratio of LaPO₄:Al₆Si₂O₁₃ of about 1:1.

In some embodiments, features from specific embodiments may be combined with features from other embodiments. For example, features from one embodiment may be combined with features from any of the other embodiments. In certain embodiments, additional features may be added to the specific embodiments described herein.

### BRIEF DESCRIPTION OF THE DRAWINGS

FIG. 1 is a flow chart showing steps in a process to form a mullite-lanthanum phosphate gel.

FIG. 2 is a flow chart showing steps in a process to form a crystalline mullite-lanthanum phosphate composite from the gel formed in FIG. 1.

FIG. 3 is a flow chart showing steps in a process to form a crystalline mullite-lanthanum phosphate coating on a substrate.

### DETAILED DESCRIPTION

A refractory, porous ceramic composite including crystalline mullite (3Al₂O₃.2SiO₂ or 3Al₆Si₂O₁₁) and a crystalline phase of LaPO₄ is formed from a mullite-LaPO₄ sol-gel by annealing the dried gel (e.g., by modifying a sol-gel to form a gel, and annealing the dried gel). During the annealing process, particle sintering and self-foaming occur in the glassy state, and pores are produced due at least in part to the release of entrapped gases that form during the pyrolysis of the gel. The resulting crystalline composite, or crystalline nanocomposite, has a porosity between about 65% and about 90% and is dimensionally and chemically stable at high temperatures. The composite also has a high degree of structural (e.g., mechanical) stability, related at least in part to the fine texturing and mixing of the mullite and LaPO₄ during preparation of the sol. The resulting ceramic composite shows little or no shrinkage or expansion between about 1000° C. and about 1200° C.

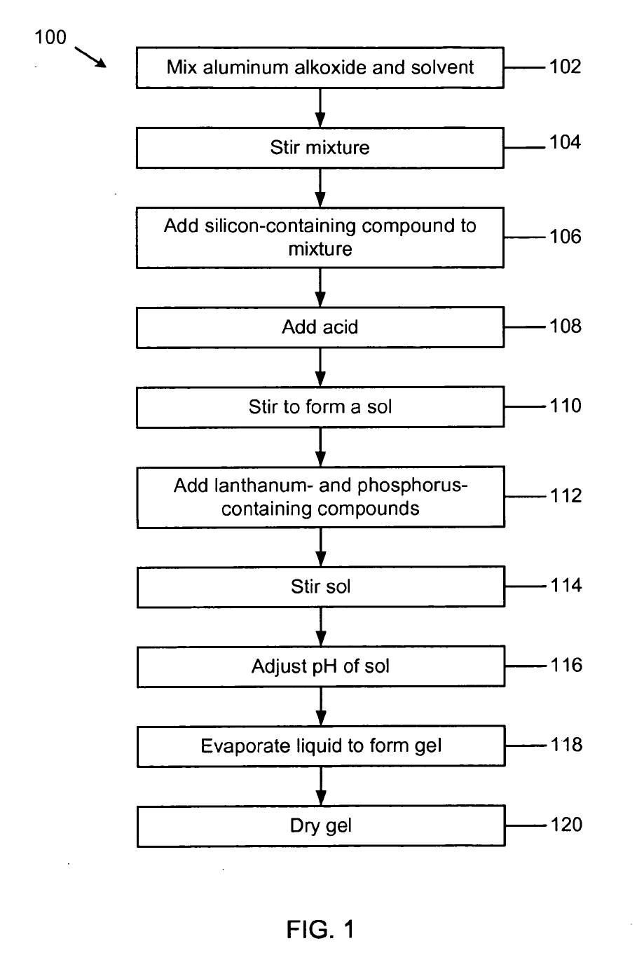

Preparation of the composite includes forming a mullite-LaPO₄ sol. FIG. 1 shows a flow chart with steps in a process 100 for forming a mullite-LaPO₄ sol. In step 102, an aluminum alkoxide is mixed with a solvent. The aluminum alkoxide may include, for example, aluminum isoproxide or aluminum sec-butoxide. The solvent may be a polar solvent including, for example, water or ethanol. The molar ratio of solvent to aluminum alkoxide may be, for example, at least about 5:1. The mixture is stirred, as shown in step 104. Stirring may continue, for example, up to 24 hours or more. After stirring, the mixture may be in the form of a suspension or a clear solution.

In step 106, a silicon-containing compound is added to the aluminum alkoxide/solvent mixture. The silicon-containing compound may be, for example, tetraethylorthosilicate (TEOS). The silicon-containing compound is added to the aluminum alkoxide/solvent mixture at a molar ratio of Si:Al between about 2:1 and about 6:1. In some cases, as shown in step 108, an acid may be added to the mixture resulting from step 106. The acid may be a strong acid, such as nitric acid. The acid may be added in a H⁺:Al molar ratio of at least about 0.5:1. The mixture may be stirred, as shown in step 110, to form a sol.

In step 112, lanthanum (La) and phosphorus (P) are added to the sol as La(NO₃)₃.6H₂O and trimethylphosphate (TMP). The sol is stirred in step 114. The sol may have a mullite content between about 40 mol % and about 80 mol %. In step 116, a pH of the sol solution may be adjusted by the addition of an acid or a base. Adjusting the pH of the sol may influence the porosity of the resulting composite. For example, an acidic sol solution (e.g., a sol solution with a pH of less than about 4, or less than about 3) may yield a composite with a higher porosity than a basic sol solution. In step 118, liquid is evaporated, and a gel is formed. In some cases, increasing the pH of the sol solution by addition of a base (e.g., ammonia) in step 116 may cause a separation (or “unmixing”) of the resulting gel into separate, finely mixed alumina-rich and silica-rich components. This “diphasic” gel does not exhibit foaming during annealing, and yields a composite with reduced porosity. The gel may be dried in step 120.

In some cases, the order of the steps in FIG. 1 may be changed. For example, in some cases, the addition of the silicon-containing compound (step 106) and the lanthanum and phosphorous compounds (step 112) may be interchanged. That is, the lanthanum and phosphorus compounds may be added in step 106, and the silicon-containing compound may be added in step 112.

In an example of process 100, aluminum isopropoxide (Al(OCH(CH₃)₂)₃) was dispersed in 100% ethyl alcohol (C₂H₅OH) at a C₂H₅OH:Al molar ratio of at least 5:1 by vigorous stirring. A white viscous suspension was obtained after about 24 hours. Tetraethylorthosilicate (TEOS) was then added to the viscous suspension at an Al:Si molar ratio between about 2:1 and about 6:1. This was followed by the addition of nitric acid (HNO₃) at a molar ratio of H⁺:Al of at least 0.5:1. After stirring for about 4 to 6 hours, a transparent sol was obtained. Lanthanum (La) and phosphorous (P) were added to the sol as La(NO₃)₃.6H₂O and trimethylphosphate (TMP), at a La(NO₃)₃:TMP molar ratio of about 1:1. After stirring for 4 hours, the clear solution was poured into a container for gelation. Sols with 60:40, 50:50, 40:60 and 20:80 ratios of LaPO₄:Al₆Si₂O₁₃ were prepared. For conditions described herein, the composition with a 50:50 ratio of LaPO₄:Al₆Si₂O₁₃ yielded the highest porosity.

In another example, aluminum sec-butoxide was mixed with water (H₂O:Al molar ratio of at least about 5:1) and HNO₃ (H⁺:Al molar ratio of at least about 0.5:1) to form a white suspension. After stirring for 24 hours, the mixture separated into two clear liquids, one on top of the other. The upper layer included sec-butanol, which was allowed to evaporate. Lanthanum (La) and phosphorous (P) were added to the sol as La(NO)₃.6H₂O and trimethylphosphate (TMP). The remaining liquid was a clear solution of prehydrolyzed aluminum alkoxide. Unhydrolyzed TEOS or prehydrolyzed TEOS was then added at an Al:Si molar ratio between about 2:1 and about 6:1. The mixture was stirred until a clear sol was formed. Liquid was allowed to evaporate from the sol, and a gel was formed in about 1 week. In some cases, mixing with prehydrolyzed TEOS yielded a translucent gel in about 5 minutes. After about a week, this translucent gel transformed to a clear sol of the mixed silicon and aluminum components. Subsequently, upon evaporation of the solvent, the clear sol transformed back into another clear gel.

The gel formed in step 120 of FIG. 1 may be annealed to form a porous ceramic composite. In some cases, the dried gel may be allowed to absorb water or re-dissolve in water. In certain cases, a dried gel may be ground into a powder and formed via standard ceramic forming techniques to fabricate a desired shape. Examples of standard ceramic forming techniques include dry pressing, isostatic pressing, slip casting, extrusion, and injection molding.

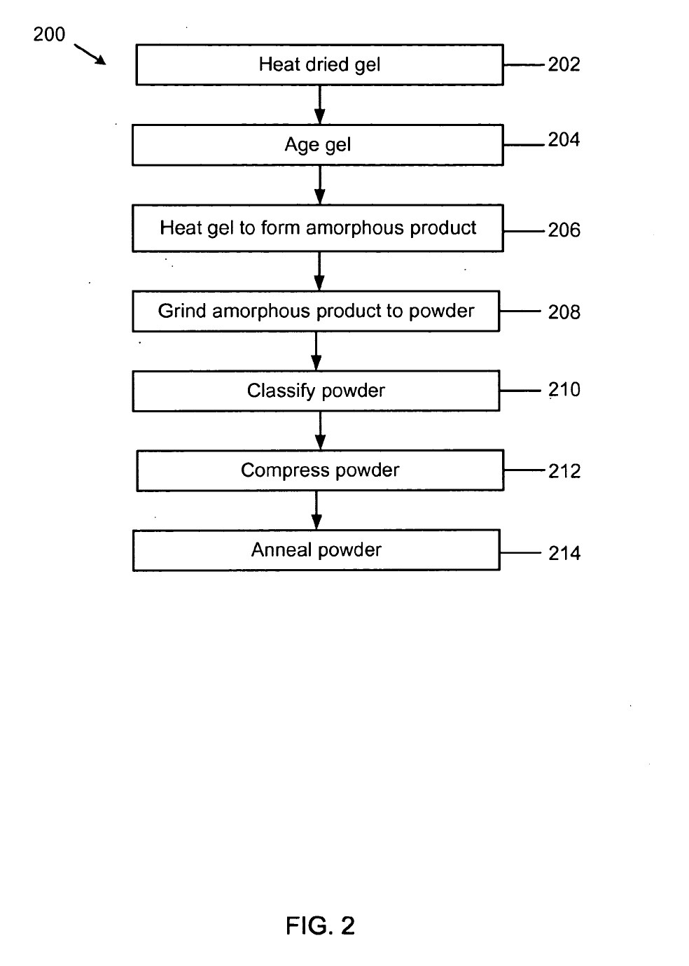

FIG. 2 is a flow chart that shows steps in a process 200 to form a refractory porous composite from the gel formed in step 120 of FIG. 1 via a combination of heating steps separated by a room temperature aging step. Process 200 includes forming an inorganic amorphous powder useful for viscous sintering at relatively low temperatures, prior to a subsequent higher temperature annealing to yield a porous crystalline or nanocrystalline composite. In some cases, this amorphous precursor may be used to produce powders for dry pressing and slurry handling. For the composite described herein, sintering or annealing may be advantageously achieved without the addition of (i.e., in the absence of) a sintering aid.

In step 202, the dried gel is heated. Heating in step 202 may include heating for various lengths of time at more than one temperature. For example, step 202 may include heating at 60° C. for 1 day followed by heating at 120° C. for a second day.

In step 204, the gel is aged. The gel may be aged under ambient conditions (e.g., room temperature and atmospheric pressure) for a length of time (e.g., for one day, two days, three days, or longer). During step 204, the composition adsorbs water. The water adsorption may advantageously suppress crystallization during subsequent annealing (e.g., in step 206).

In step 206, the composition is heated. Heating in step 206 may include annealing. In some cases, heating in step 206 includes heating to a first temperature at a first heating rate, and heating to a second temperature at a second heating rate. For example, heating in step 206 may include heating to about 600° C. at a rate in a range between about 1° C./minute and about 10° C./min, and then heating to about 800° C. at a rate in a range between about 5° C./minute and about 20° C./minute. The total heating time may vary based at least in part on heating rate. For example, when using heating rate of 1° C./minute below 600° C. and 5° C./minute between 600-800° C., the total heating time is about 15 hours.

Heating in step 206 may include annealing for a length of time. The annealing time may be considered independently of the ramp time. For example, after a composition is heated up to 800° C., the composition may be annealed for about 4 hours at about 800° C. to yield a white amorphous product. A faster heating rate may yield a powder with some crystalline nature. However, porous ceramics prepared from amorphous powders and slightly crystalline powders and have almost identical porosity.

In step 208, the product is ground into a powder. The powder may be classified, as indicated in step 210. For example, the powder may be classified using mechanical sieves. Powders with a particle size of less than about 50 μm may be collected. This amorphous powdered product may be compressed into green bodies in step 212. Pressing may include, for example, uniaxial or isostatic pressing.

In step 214, the compressed powder compacts are annealed by heating, for example, between about 900° C. and about 1400° C., between about 900° C. and about 1200° C., between about 900° C. and about 950° C., or at about 950° C. for a length of time to yield a desired porosity. In a comparison of annealing times and temperatures, annealing a 1:1 LaPO₄:Al₆Si₂O₁₃ composite at 950° C. for 30 minutes produced a maximum porosity. In this annealing step, particle sintering and foaming occur while still in the glassy state (e.g., starting at about 900° C.). Pores are produced at least due in part to the release of entrapped gases that form during the pyrolysis of the gel. The degree of porosity may be controlled by the annealing temperature and the length of heating. For example, a composite may have a porosity of 85% after annealing at 950° C. Above about 950° C., the resultant porosity may decrease, thought to be due at least in part to gases leaking more efficiently through open pore networks, partial crystallization beginning in this temperature range, or a combination thereof The porosity may decrease to about 80% after additional annealing at a temperature between about 1000° C. and about 1200° C.

In some cases, degree of foaming reaches a maximum at about 950° C., with most of the pores closed. Heating to higher temperatures (e.g., above about 1000° C.) may yield more open porosity. In some cases, thermal expansion of enclosed gases after crystallization may cause breakage of pore walls and contribute to open porosity. As used herein, “open porosity” refers to the volume percentage of pores connected with ambient atmosphere; “closed porosity” refers to the volume percentage of pores which are isolated from ambient atmosphere; “total porosity” refers to the sum of open porosity and closed porosity.

Porosity between about 65% and about 90% may be obtained for ceramics annealed below about 1200° C. In an example, the porosity of a composite with a 1:1 ratio of LaPO₄:Al₆Si₂O₁₃ after annealing at 1200° C. is between about 80% and about 85%. For other ratios of LaPO₄:Al₆Si₂O₁₃, the porosity after annealing at 1200° C. is between about 65% and about 80%. Further annealing at 1200° C. for 1 hour resulted in little or no shrinkage or change in porosity, and thus is indicative of a long structural stability at 1000° C. In an example, a composite with a porosity of about 80% heated to 1400° C. for seven days yielded a composite with a porosity of about 65%.

For ceramics annealed below about 1200° C., the pore size distribution may be bimodal. A bimodal pore size distribution may include, for example, larger pores with a diameter between about 1 μm and about 5 μm, and smaller pores with a diameter between about 10 nm and about 100 nm. In some cases, the small pores are embedded in the walls of the larger pores. With increasing anneal temperature, some of the pores (e.g., the smaller pores), may shrink to smaller sizes. The resulting network of open pores, interconnected with one another and with the furnace environment, is broadened and more extensive. Various conditions in the annealing stage are found to yield porous networks that are relatively stable for long periods of time (e.g., stable with respect to shrinkage between about 1000° C. and about 1200° C.).

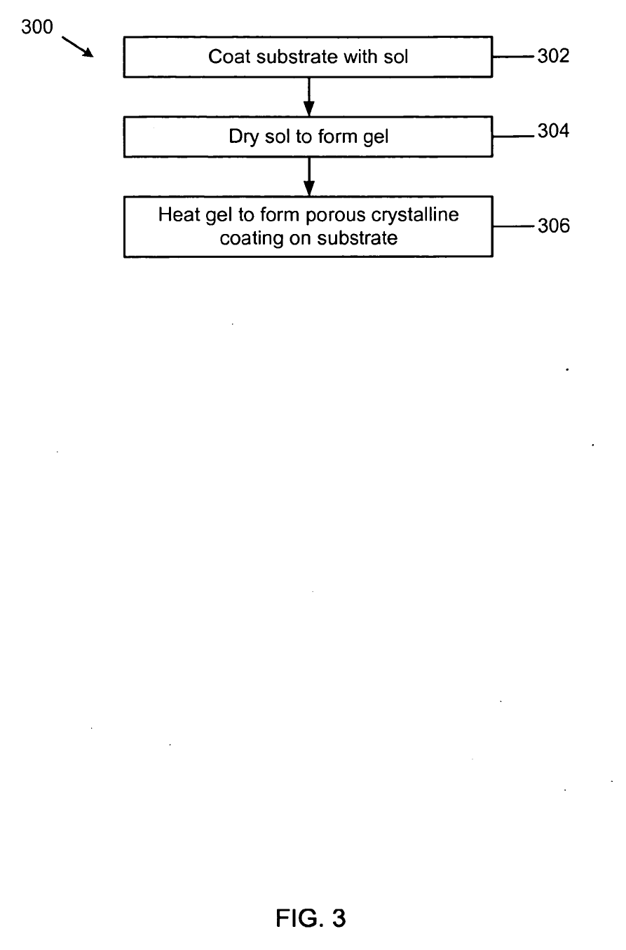

In another example, direct fabrication of refractory porous ceramics may be accomplished by coating a substrate with a sol prepared as described in FIG. 1. FIG. 3 shows a flow chart with steps in process 300 for forming a porous ceramic composite on a substrate. In step 302, a substrate is coated with a sol prepared as described in FIG. 1. The substrate may include, for example, single fibers or woven fiber cloth. Coating may include, for example, dip coating or spray coating. In some cases, the substrate is immersed in a sol and removed from the sol at a rate selected to coat the substrate as desired. For example, the substrate may be lifted from the sol at a constant rate (e.g., between about 10 mm/minute and about 100 mm/minute). In step 304, a gel coating is formed on the substrate as the sol dries (e.g., in air). Forming the gel may occur in less than about 10 minutes or less than about 5 minutes. In some cases, the gel coating is substantially uniform in thickness.

In step 306, the coated substrate is heated to convert the gel into a glass and then to a crystalline composite material with a desired porosity. Step 306 may include annealing the dried gel. For example, the coated substrate may be heated to about 950° C. (e.g., at a rate of about 1° C./minute to about 20° C./minute) and sintered at 950° C. (e.g., for at least about 30 minutes), and then heated to a higher temperature (e.g., to over 1000° C. at a rate of about 5° C./minute to about 20° C./minute). In some cases, higher temperatures yield lower porosities. The porosity of this coating may be similar to that of the bulk composite ceramics formed as described in FIG. 2 above. That is, the porosity of this coating may be at least about 80% when the annealing temperature is less than about 1200° C.

A solids content of the crystalline composite material may be adjusted up to about 40 wt %. When the solids content is lower than about 40%, the sol is still able to flow freely and can be coated onto a substrate. When the solids content is higher than about 40%, the sol gelates, and does not flow freely.

In some cases, cracks may form in a mullite-LaPO₄ gel composition as it dries on a substrate, for example, in the processes shown in FIGS. 2 and 3. Self-foaming of the composition during annealing may fill in cracks formed during drying of the gel or a composition derived from the gel (e.g., a slurry formed from the amorphous powder in FIG. 2). This self-foaming, and the volume increase that occurs during the foaming, may yield a substantially defect-free (e.g., crack-free) coating on the substrate. This is in contrast to traditional sol-gel coating processes, which often preserve cracks after annealing. To avoid cracks resulting from traditional sol-gel coating processes, coatings formed by these traditional processes may have limited thickness (e.g., less than about 100 nm). The thermal insulating and heat shedding properties of coatings formed by traditional sol-gel processes may be therefore be limited by the thickness of the coatings.

In contrast, the porous ceramic coatings described herein, by way of the self-foaming and concurrent healing induced by viscous flow of the glass-ceramic to seal the cracks during annealing, allow the formation of thicker crack-free composite layers (e.g., at least about 20 μm). The added thickness of these layers provides enhanced volume-dependent properties such as thermal insulating and heat shedding properties. In some cases, a substrate may be coated with one or more additional layers of a mullite-LaPO₄ crystalline composite coating. The additional layers may be used to achieve an increased thickness of the coating and thereby enhance properties (i.e., thermal properties) related to a thickness of the coating. In certain cases, a substrate may be coated with the self-foaming mullite-LaPO₄ composite to repair cracks or other flaws in the coating.

The porous ceramics produced as described herein show chemical and structural stability under high temperature oxidizing atmospheres, low thermal conductivity (e.g., less than about than 1 W/(m·K) at 1000° C.), and less than about 2% or less than about 1% volume shrinkage between about 1000° C. and about 1200° C. Accordingly, these ceramics may be used in a variety of thermal and structural applications. In some cases, the high porosity and intricate pore structure of these mullite-LaPO₄ composites provide an approach for reducing the thermal conductivity of a solid, with the reduction in thermal conductivity due at least in part to the low intrinsic conductivity of the pores themselves and the tortuous paths required for heat to transport through the solid phase. Other thermal applications include, but are not limited to, thermal insulation bricks (e.g., for use in high-temperature furnaces), thermal barrier coatings (e.g., used to provide heat flow resistance to metal and ceramic substrates), bonding agents for fibers in thermal insulation bricks (e.g., in continuous bonding layers for fiber reinforced ceramic composites), high temperature catalyst carriers, and the like. Structural applications include matrices ceramic matrix composites (CMCs) and in continuous fiber ceramic composites (CFCCs), as well as coatings for fibers in CFCCs. Compatible fibers for the CFCC composites include oxide fibers such as, for example, mullite, which is chemically compatible with the phases of a mullite-LaPO₄ composite.

As a bonding layer between ceramic fibers and matrices in CFCCs, the porous coating provides the low bonding strength needed to divert crack propagation and to decouple the fiber from the matrix during critical events that otherwise might cause fractures. Because such materials may be targeted for use at high temperatures, it is desirable that this bonding layer be microstructurally stable for maintaining long-term service. Thermal barrier coatings may be frequently cycled between high and low temperatures. The service of such materials may be limited by internal changes that occur while at high temperatures for long periods of time, which may result in mechanical weakening and diminution of thermal properties. The two-phase structure of the mullite-LaPO₄ crystalline and nanocrystalline composites described herein may help to resist degradation and inhibit cycling fatigue, thereby extending the lifetime of an application.

Damage tolerance in CFCCs may be improved by high matrix porosity and low bonding strength coatings, as well as fugative coatings that help form a gap between the fiber and the matrix. When porous matrices are bonded directly to high strength ceramic fibers, the high porosity introduces a resultant low interface bonding strength. This low interface bonding strength helps to improve fracture toughness, which is interpreted in terms of the total energy of fracture. Low interface bonding strength may also introduce insensitivity to the geometry of strength-limiting cracks.

The self-foaming that occurs in the annealing process described herein can produce ceramics with high porosities and still provide for increased damage tolerance and bonding capacity for the composite structure. Sintering and foaming of the mullite-LaPO₄ composition includes viscous flow of a liquid-like material. Consequently, formation of a continuous glass network and the volume expansion due to foaming is simultaneously achieved. This process may be faster than the solid state sintering of crystalline material, and may yield a skeletal strength greater than that of a matrix with comparable porosity formed by other methods.

Composites described herein may also be used as dimensionally stable catalyst substrates, for high and low temperature use. The composites have high surface area density (i.e., high areal density) and are substantially chemically inert and mechanically tough, due at least in part to the fine composite texturing of the LaPO₄ and mullite.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A ceramic composite comprising:
crystalline mullite; and
crystalline lanthanum phosphate,
wherein a porosity of the composite is between about 65% and about 90%.

2. The composite of claim 1, wherein the porosity of the composite is at least 80%.

3. The composite of claim 1, wherein the composite, when heated at a temperature between about 1000° C. and about 1200° C. exhibits a change in volume of less than 2%.

4. The composite of claim 1, wherein a thermal conductivity of the composite is less than about 1 W/(m·K) at 1000° C.

5. The composite of claim 1, wherein the composite defines a multiplicity of pores, and the multiplicity of pores comprises a bimodal pore distribution.

6. The composite of claim 5, wherein the bimodal pore distribution comprises a first set of pores with diameters in a range between about 1 micron and about 5 microns and a second set of pores with diameters in a range between about 10 nanometers and about 100 nanometers.

7. The composite of claim 1, wherein the composite is a nanocrystalline composite.

8. A thermal barrier coating formed by the composite of claim 1.

9. A bonding layer between ceramic fibers and matrices in a continuous fiber ceramic composite, the bonding layer formed by the composite of claim 1.

10. A thermal insulation brick formed by the composite of claim 1.

11. A ceramic matrix formed by the composite of claim 1.

12. A substrate comprising a coating, wherein the coating comprises a mullite-lanthanum phosphate crystalline composite with a porosity between about 65% and about 95%.

13. The substrate of claim 12, wherein the porosity of the composite is at least 80%.

14. The substrate of claim 12, wherein the substrate comprises a fiber in a continuous fiber ceramic composite, a metal substrate, or a ceramic substrate.

15. (canceled)

16. A method comprising:
combining an aluminum alkoxide and a solvent to form a mixture;
adding a silicon-containing compound, a lanthanum-containing compound, and a phosphorous-containing compound to the mixture; and
processing the mixture to form a sol comprising mullite and lanthanum phosphate.

17. The method of claim 16, further comprising:
evaporating a liquid from the sol to form a gel;
drying the gel to form a powder; and
annealing the powder to form a crystalline composite.

18. The method of claim 16, further comprising:
coating a substrate with the sol;
drying the sol to form a gel; and
annealing the gel to form a crystalline composite coating on the substrate.

19. The method of claim 17, wherein annealing the powder comprises self-foaming of a glassy state of the powder.

20-25. (canceled)

26. The method of claim 17, wherein annealing the powder comprises annealing at a temperature between about 900° C. and about 1400° C.

27-28. (canceled)

29. The method of claim 18, wherein annealing the gel comprises self-foaming of a glassy state of the gel.

30-31. (canceled)
